(19) United States
(12) Patent Application Publication
(10) Pub. No.: US 2026/0329235 A1
(43) Pub. Date: Oct. 22, 2026

(54) Power-Managed Physical Impact Detection for Wearable Devices

(71) Applicant: Google LLC, Mountain View, CA (US)

(72) Inventor: Ray Ling Chang, Saratoga, CA (US)

(73) Assignee: Google LLC, Mountain View, CA (US)

(21) Appl. No.: 19/694,133

(22) Filed: Jun. 1, 2026

(51) Int. Cl. G04G 19/00; G04G 21/08; G06F 3/0346

(52) U.S. Cl. CPC G04G 19/00; G04G 21/08; G06F 3/0346

(57) ABSTRACT

Processing physical input while managing power consumption is a consideration for wearable devices. At least one processor operating in a first power state receives a sensor data stream from a motion sensor and determines whether a first portion of the data stream satisfies a stability condition. Responsive to determining that the first portion satisfies the stability condition, the at least one processor detects a physical impact on the wearable device based on a second portion of the data stream. Detecting the physical impact triggers a transition of the at least one processor to a second power state that consumes more power than the first power state. While operating in the second power state, the at least one processor classifies the physical impact as an intentional tap input and executes an action mapped to the intentional tap input, facilitating input detection while managing system power.

### SUMMARY

This document describes methods implemented on wearable mobile devices (e.g., smartwatches and other wearable devices), directed at power-managed physical impact detection for wearable devices. These methods offer a power-efficient interaction model that leverages an integrated motion sensor to detect intentional user taps on the device housing. By establishing a multi-level software-driven gesture system, the described methods provide highly accessible user shortcuts without relying on physical hardware buttons, which reduces manufacturing complexity, conserves internal space, and simplifies water-sealing constraints.

In general, a first aspect of the present disclosure relates to a method for power-managed physical impact detection for wearable devices. The method includes receiving, by at least one processor of a wearable device operating in a first power state, a sensor data stream from a motion sensor. The method includes determining, by the at least one processor operating in the first power state, that a first portion of the sensor data stream satisfies a stability condition. Responsive to the determination that the first portion satisfies the stability condition, the method includes detecting, by the at least one processor operating in the first power state, a physical impact on the wearable device based on a second portion of the sensor data stream. The method further includes, responsive to the detection of the physical impact, transitioning the at least one processor to a second power state that consumes more power than the first power state. The method also includes classifying, by the at least one processor operating in the second power state, the physical impact as an intentional tap input. The method includes executing an action mapped to the intentional tap input.

A second aspect of the present disclosure relates to a wearable device. The wearable device includes a motion sensor, at least one processor communicatively coupled to the motion sensor, and at least one memory storing instructions that, when executed by the at least one processor, cause the wearable device to perform operations. The operations include receiving, while the at least one processor is operating in a first power state, a sensor data stream from the motion sensor. The operations include determining, while the at least one processor is operating in the first power state, that a first portion of the sensor data stream satisfies a stability condition. Responsive to the determination that the first portion satisfies the stability condition, the operations include detecting, while the at least one processor is operating in the first power state, a physical impact on the wearable device based on a second portion of the sensor data stream. The operations further include, responsive to the detection of the physical impact, transitioning the at least one processor to a second power state that consumes more power than the first power state. The operations also include classifying, while the at least one processor is operating in the second power state, the physical impact as an intentional tap input, and executing an action mapped to the intentional tap input.

This document also describes computer-readable media having instructions for performing the above-summarized methods and other methods set forth herein, as well as systems and means for performing these methods.

This Summary is provided to introduce simplified concepts for power-managed physical impact detection for wearable devices, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of power-managed physical impact detection for wearable devices are described throughout the disclosure, with reference to the drawings. The use of the same reference numbers in different instances in the detailed description and the drawings indicates same or similar elements:

FIG. 1 illustrates an example operating environment for power-managed physical impact detection for wearable devices;

FIG. 2 illustrates an example block diagram of a wearable device for power-managed physical impact detection for wearable devices;

FIG. 3 illustrates an example flow diagram for power-managed physical impact detection for wearable devices;

FIG. 4 illustrates an example timing diagram of acceleration amplitude and system power consumption for power-managed physical impact detection for wearable devices;

FIG. 5 illustrates example user interface interactions for multi-stage gating architecture for inertial tap detection;

FIG. 6 illustrates an example method for power-managed physical impact detection for wearable devices.

### DETAILED DESCRIPTION

Wearable devices operate in highly constrained physical environments where exterior surface area and internal volume are at a premium. Users interacting with these devices frequently benefit from immediate, accessible input mechanisms to perform quick actions without navigating through complex digital menus or utilizing precise touchscreen gestures. For example, a user may seek to initiate a workout, activate a utility such as a flashlight in a dark environment, or trigger a custom routine with reduced user effort. Accommodating such immediate interactions can involve integrating physical input components, which may introduce external design constraints related to environmental sealing and manufacturing complexity, while also consuming internal space.

To provide flexible and accessible input, power-managed physical impact detection for wearable devices may be implemented to enable customizable, virtual action triggers. By leveraging built-in motion sensors, a wearable device can detect physical impacts, such as intentional finger taps, applied directly to the exterior housing of the device. This approach allows the rigid housing of the wearable device to function as a multi-level input surface. A user can simply tap the side of the device casing to execute an immediate action, such as launching a frequently used application, opening a user-configurable quick-action menu, or confirming a prompt.

The architecture is designed to manage system power consumption efficiently by utilizing multiple processing states and sequential gating conditions. In some implementations, the system monitors a sensor data stream while operating in a low-power sensing mode. To filter out unintended input from general arm movements, the system may evaluate a stability condition to establish that the device is relatively stationary before proceeding with advanced input detection. Once a stable baseline is established, an initial detection of a localized physical impact can generate a trigger that transitions the device to a higher-power processing state. This multi-stage approach facilitates invoking power-intensive analytical processing primarily when an intentional user input is highly probable.

Upon transitioning to the higher-power state, the system classifies the captured sensor data to confirm whether the physical impact represents an intentional tap input. This classification process evaluates the kinematic signature of the data to distinguish a user's tap from incidental bumps, external vibrations, or natural physiological movements. Once confirmed, the system executes an operation mapped to the specific input, such as triggering a discrete action for a single tap or outputting an assignment interface for a multi-tap event.

Implementing an inertial tap detection system provides various technical effects and advantages for wearable devices. By relying on internal motion sensors to register user inputs, the reliance on dedicated physical hardware buttons may be reduced. This software-driven approach can conserve internal space within the device housing, potentially allowing for the inclusion of other internal hardware components or increased battery capacity. The reduction of physical button apertures may also simplify overall manufacturing and environmental water-sealing processes. Further, by accurately parsing user intent through the multi-stage gating architecture, this approach establishes a multi-level interaction toolkit that can manage system power efficiency while enhancing device usability.

### Example Environment

The following discussion describes an operating environment, techniques that may be employed in the operating environment, and various devices or systems in which components of the operating environment may be embodied. In the context of the present disclosure, reference is made to the operating environment by way of example only.

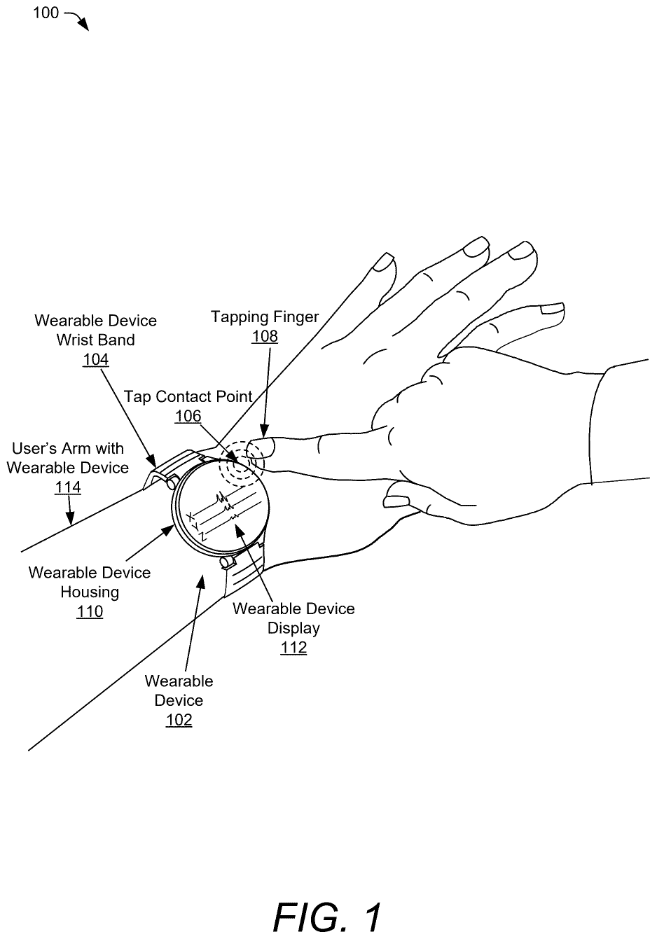

FIG. 1 illustrates an example operating environment 100 for power-managed physical impact detection for wearable devices. In the operating environment 100, a user interacts with a computing apparatus using physical gestures applied directly to an exterior structure of the computing apparatus. By leveraging motion sensing capabilities, the operating environment 100 supports the detection and classification of intentional taps, which allows the computing apparatus to execute commands based on physical impacts.

The operating environment 100 includes a wearable device 102. The wearable device 102 operates as a personal computing device that a user wears during daily activities. The wearable device 102 may take various forms, such as a smartwatch, a fitness tracker, a health monitoring device, or another type of connected apparatus. To secure the wearable device 102 to the user, the operating environment 100 includes a wearable device wrist band 104. The wearable device wrist band 104 couples to the wearable device 102 and fastens around a wrist or an arm of the user, keeping the wearable device 102 in a relatively fixed position. The wearable device wrist band 104 can include various flexible or rigid materials, such as silicone, leather, woven fabric, or metal links, and can accommodate varying degrees of tightness based on user preference.

To initiate an interaction with the wearable device 102, the user generates an input at a tap contact point 106. The tap contact point 106 represents a physical location on the exterior of the wearable device 102 that receives kinetic energy. The user generates this impact using a tapping finger 108. The tapping finger 108 makes physical contact or strikes at the tap contact point 106. In some implementations, the tap contact point 106 is located on a wearable device housing 110. The wearable device housing 110 serves as a structural enclosure for the internal electronic components of the wearable device 102, such as internal motion sensors, batteries, and processors. The wearable device housing 110 may include a rigid or semi-rigid material, such as aluminum, stainless steel, titanium, polycarbonate, or other synthetic polymers. When the tapping finger 108 strikes the wearable device housing 110 at the tap contact point 106, the material of the wearable device housing 110 transfers the resulting kinetic energy and acoustic vibrations to the internal components. This transfer of energy allows the wearable device 102 to detect inputs without utilizing a dedicated mechanical button or a switch mechanism at the tap contact point 106. A user may apply the tapping finger 108 to various distinct locations around the perimeter of the wearable device housing 110, such as a top edge, a bottom edge, or a side edge.

The wearable device 102 further includes a wearable device display 112 disposed at least partially within the wearable device housing 110. The wearable device display 112 presents a graphical user interface, visual feedback, notifications, or internal data representations to the user. The wearable device display 112 may include a touch-sensitive organic light-emitting diode screen, an active-matrix organic light-emitting diode screen, or a liquid-crystal display. As depicted in the operating environment 100, the wearable device display 112 may output representations of internal sensor data, such as a multi-axis motion waveform representing x-axis, y-axis, and z-axis acceleration data. In some scenarios, when the wearable device 102 detects an input from the tapping finger 108 on the wearable device housing 110, the wearable device 102 updates the wearable device display 112 to acknowledge the input. For example, the wearable device 102 may instruct the wearable device display 112 to show a visual ripple effect expanding outward from the tap contact point 106, to open a specific application, or to transition to a different user interface menu.

The wearable device 102 and the wearable device wrist band 104 operate while worn on a user's arm with wearable device 114. The user's arm 114 provides a physiological foundation and physical backstop during the tap interaction. When the tapping finger 108 applies force to the wearable device housing 110, the user's arm 114 absorbs a portion of the kinetic energy, stabilizing the wearable device 102 and restricting excessive shifting or wobbling. This physical stabilization allows the wearable device 102 to register a clear, distinguishable kinematic signature rather than a scattered or prolonged vibration profile. Further, the user's arm 114 establishes a stable baseline (e.g., less than approximately a 0.2 g to 0.25 g change) for motion detection when held relatively stationary. By providing a steady orientation relative to a gravity vector, the user's arm 114 supports the isolation of specific, localized acceleration changes introduced by the tapping finger 108 from other general arm movements.

In an example operational sequence within the operating environment 100, the user holds the user's arm 114 relatively steady. The wearable device 102 monitors internal sensor data streams while operating in a sensing mode and confirms that the user's arm 114 maintains a stable baseline. Following this period of stability, the user brings the tapping finger 108 toward the wearable device 102 and strikes the wearable device housing 110 at the tap contact point 106. The wearable device 102 detects this localized physical impact by analyzing the fluctuations in the internal sensor data. The wearable device 102 processes the characteristics of the impact, evaluating a kinematic signature of the impact to classify the impact as an intentional user input rather than an accidental bump against an object or a natural physiological arm movement.

Continuing the example operational sequence, upon classifying the impact as an intentional input from the tapping finger 108, the wearable device 102 executes a corresponding programmed action. For example, if the tapping finger 108 performs a single tap at the tap contact point 106, the wearable device 102 may execute a discrete action, such as launching a media player application, answering an incoming voice call, or logging a workout event. In some implementations, the wearable device 102 supports multi-tap interactions, such as a double tap or a triple tap. If the tapping finger 108 strikes the wearable device housing 110 multiple times in rapid succession, the wearable device 102 may output a dynamic selection menu on the wearable device display 112, allowing the user to select between different quick-action functions. Through these interactions, the operating environment 100 transforms the exterior of the wearable device housing 110 into an accessible, multi-level input surface.

### Example Devices and Systems

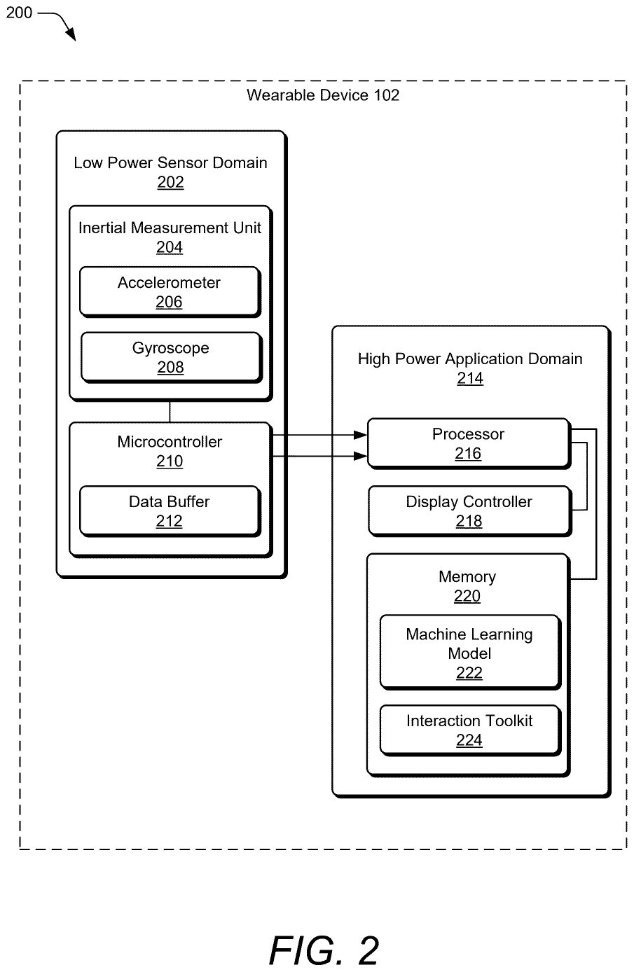

FIG. 2 illustrates an example overall architectural diagram 200 of a wearable device 102 for power-managed physical impact detection for wearable devices. The overall architectural diagram 200 represents a hardware and software system configuration that partitions computational workloads across different power states. By segregating continuous motion monitoring from complex pattern classification, the wearable device 102 manages electrical power consumption while remaining responsive to physical user inputs applied to the exterior of the device.

The wearable device 102 includes a low power sensor domain 202 (operating at, for example, 50 Hz sampling frequency). The low power sensor domain 202 operates as an active background subsystem that consumes a relatively small amount of power compared to main computing components. Within the low power sensor domain 202, the wearable device 102 includes an inertial measurement unit 204. The inertial measurement unit 204 continuously or periodically captures physical motion and spatial orientation data. To capture this data, the inertial measurement unit 204 includes an accelerometer 206 and a gyroscope 208. The accelerometer 206 measures linear acceleration forces along multiple internal axes, such as an x-axis, a y-axis, and a z-axis, which can indicate changes in velocity, a direction of gravitational pull, or sudden kinetic impacts against the device. The gyroscope 208 measures angular velocity and rotational motion around these axes, providing context about the orientation, tilting, and twisting movements of the wearable device 102.

To process the data generated by the inertial measurement unit 204, the low power sensor domain 202 includes a microcontroller 210. The microcontroller 210 functions as a dedicated sensor hub or low-power processor that evaluates the incoming sensor data stream without engaging more power-intensive processing components. The microcontroller 210 may perform initial signal filtering, threshold comparisons, and basic edge detection operations. While monitoring the sensor data stream, the microcontroller 210 stores portions of the data in a data buffer 212. The sensor data stream may include a first portion used to determine the stability condition, and a second portion used to detect the physical impact. For example, the microcontroller 210 may buffer the second portion of the sensor data stream in the memory while the at least one processor is operating in the first power state. The data buffer 212 may operate as a circular queue or a first-in-first-out memory structure that temporarily holds a recent time window of motion data. For example, the data buffer 212 may retain a recent window of continuous sensor readings from the accelerometer 206 and the gyroscope 208, overwriting older data as new data arrives.

The wearable device 102 also includes a high-power application domain 214 (operating at, for example, 190 Hz-1000 Hz sampling frequency). The high-power application domain 214 manages complex computational tasks, user interface generation, and operating system functions. Operating the high-power application domain 214 consumes more electrical power than operating the low power sensor domain 202. Within the high-power application domain 214, the wearable device 102 includes a processor 216. The processor 216 serves as the main central processing unit or application processor for the wearable device 102. To conserve battery power, the processor 216 may remain in a sleep, idle, or suspended state until receiving a hardware interrupt, a wake signal, or a wake-up interrupt from the microcontroller 210. The high-power application domain 214 further includes a display controller 218 communicatively coupled to the processor 216. The display controller 218 receives rendering instructions from the processor 216 and drives graphical output to a physical display panel, managing frame rates, pixel illumination, and visual feedback animations in response to user inputs.

The high-power application domain 214 incorporates a memory 220. The memory 220 can include various volatile and non-volatile storage mediums, such as random-access memory and flash storage, configured to hold executable instructions, application data, and system configurations. The memory 220 stores a machine learning model 222 (which may also be referred to as a machine-learned model). The processor 216 executes the machine learning model 222 to analyze complex kinematic data patterns. The machine learning model 222 may be fine-tuned or customized during a device setup phase to establish a baseline, user-specific kinematic signature. The machine learning model 222 may be previously trained on various data sets including positive examples of intentional housing taps and negative examples of ambient movements, such as a user typing on a keyboard, clapping hands, jogging, or bumping an arm against a table. The memory 220 also stores an interaction toolkit 224. The interaction toolkit 224 includes configurations, software hooks, application programming interfaces, and mapping profiles that link specific classified inputs to defined system actions. For instance, the interaction toolkit 224 may map a detected single tap to an action like dismissing an alarm, or map a double tap to an action like launching a specific application.

In an example operational sequence utilizing the components of the overall architectural diagram 200, the wearable device 102 operates in a resting state where the high-power application domain 214 sleeps to conserve power, and the low power sensor domain 202 remains active. The inertial measurement unit 204 generates a continuous stream of motion data using the accelerometer 206 and the gyroscope 208. The microcontroller 210 evaluates this data stream at a relatively low sampling rate, checking for a stable baseline condition which indicates the user is holding their wrist relatively still. While monitoring the movement, the microcontroller 210 continuously writes the incoming sensor data to the data buffer 212. When a user intentionally taps the exterior housing of the wearable device 102, the accelerometer 206 registers a sudden kinematic impact. The microcontroller 210 detects this spike using a basic magnitude threshold or peak detection logic.

Continuing the example operational sequence, upon detecting the impact spike, the microcontroller 210 issues a wake-up trigger to the high-power application domain 214. The processor 216 transitions from the sleep state to an active state and retrieves the recent historical motion data stored in the data buffer 212. The processor 216 processes this buffered data through the machine learning model 222 to evaluate the waveform signature of the impact. If the machine learning model 222 classifies the signature as an intentional tap event rather than an accidental bump, the processor 216 accesses the interaction toolkit 224 to resolve the appropriate programmed response. Following the resolution of the programmed response, the processor 216 commands the display controller 218 to update the user interface, executing the input interaction while managing the overall power consumption of the wearable device 102.

In some implementations, the wearable device 102 may further include an acoustic sensor, such as a microphone. The microcontroller 210 or processor 216 may evaluate acoustic data in combination with the sensor data stream to classify the physical impact, which may improve tap detection accuracy when the device is not strictly stationary (e.g., during physical exercise).

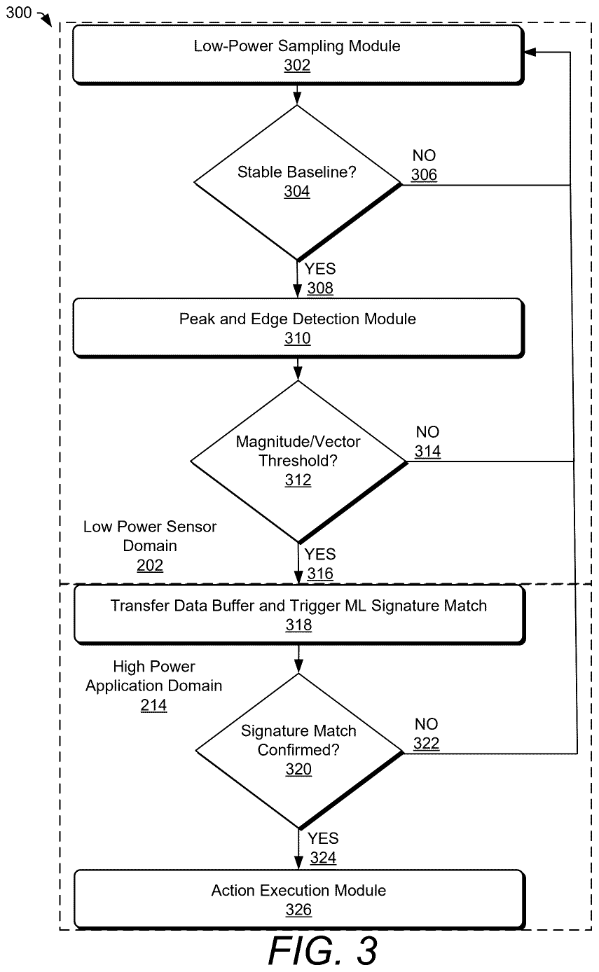

FIG. 3 illustrates an example overall logic flowchart 300 for power-managed physical impact detection for wearable devices. The overall logic flowchart 300 represents a sequence of operations that a wearable device performs to evaluate physical inputs through progressively more intensive computational checks. The overall logic flowchart 300 is divided across distinct operational boundaries, specifically a low power sensor domain 202 and a high-power application domain 214. By gating complex processing operations behind preliminary stability and impact checks, the wearable device manages energy consumption while accurately identifying intentional user interactions.

At 302, the wearable device executes a low-power sampling module 302 to continuously monitor motion data while operating within the low-power sensor domain 202. The wearable device polls an internal motion sensor at a relatively low frequency to capture background kinetic activity without drawing substantial electrical current. For example, a user wearing the wearable device may be typing on a keyboard or walking, and the wearable device utilizes the low-power sampling module 302 to capture ambient acceleration and rotational changes associated with these typical movements.

At 304, the wearable device evaluates a condition at the stable baseline decision node 304 to determine whether the captured motion data indicates that the wearable device is relatively stationary. The wearable device analyzes the incoming data from the low-power sampling module 302 to verify that fluctuations along a gravity vector remain below a predetermined threshold for a predefined duration, which establishes a stable foundation for detecting subsequent kinetic impacts. For example, if the user holds their wrist steady for a fraction of a second, the wearable device evaluates this state at the stable baseline 304 decision node and detects this localized stability to proceed to the next analysis stage.

At 306, the wearable device proceeds along the NO path 306 if the stable baseline 304 decision node condition is not met, returning operation to the low-power sampling module 302. The wearable device determines the environment is too unstable to reliably isolate an impact. For example, if the user is actively jogging, the wearable device registers continuous high-amplitude variations, taking the NO 306 path to avoid false positive detections.

At 308, the wearable device follows a YES 308 path if the stable baseline 304 decision node condition is met. The wearable device confirms the presence of a steady physical foundation, preparing for impact detection. For example, after the user rests their arm on a table, the wearable device follows the YES 308 path to transition into a state actively anticipating a localized physical impact.

At 310, the wearable device activates a peak and edge detection module 310 in response to following the YES 308 path. Operating still within the low-power sensor domain 202, the wearable device analyzes subsequent motion data, potentially increasing a sampling rate, to search for sharp, sudden spikes in acceleration that characterize a physical impact on a housing of the wearable device. For example, when the user strikes the exterior casing of the wearable device with a finger, the wearable device uses the peak and edge detection module 310 to identify the steep leading edge of the resulting kinetic wave, which differs distinctly from smooth, sweeping arm movements. This helps to determine a physical location of the physical impact relative to a housing of the wearable device.

At 312, the wearable device evaluates a magnitude/vector threshold 312 decision node to confirm whether the detected impact meets predetermined spatial and force criteria. The wearable device calculates a directional vector and an overall amplitude of the detected peak from the peak and edge detection module 310 to determine if the impact aligns with an expected profile of a housing tap. For example, the wearable device evaluates the magnitude/vector threshold 312 decision node to check whether the detected force exceeds a baseline structural vibration and aligns with a vector originating from an exterior edge of the housing.

At 314, the wearable device takes a NO 314 path if the impact characteristics fail the evaluation at the magnitude/vector threshold 312 decision node. The wearable device discards the event to avoid false positive input triggers and returns to the low-power sampling module 302. For example, if the physical impact is exceptionally soft or originates from an anomalous direction, such as a glancing bump against a doorframe, the wearable device may classify the event as incidental and take the NO 314 path back to the low-power sampling module 302.

At 316, the wearable device proceeds along a YES 316 path if the magnitude and vector characteristics align with an intentional tap. The wearable device clears the hardware-level gating stages and prepares to wake higher-power components. For example, when a distinct, firm tap strikes the designated area of the housing, the wearable device validates the impact profile, takes the YES 316 path, and marks a transition out of the low power sensor domain 202.

At 318, the wearable device performs a transfer data buffer and trigger ML signature match 318 operation, bridging the operations into the high-power application domain 214. The wearable device copies a recent window of motion data, which contains the stable baseline and the detected impact waveform, from a low-power buffer to a main system memory while simultaneously generating a hardware interrupt to wake a primary processor. For example, the wearable device transfers a block of multi-axis acceleration data to an application processor and executes the transfer data buffer and trigger ML signature match 318 operation to evaluate the frequency response and ringing characteristics of the physical strike using a pattern recognition algorithm.

At 320, the wearable device evaluates a signature match confirmed 320 decision node to finalize a classification of the physical input. The wearable device utilizes a machine learning model operating within the high-power application domain 214 to compare the buffered data against learned kinematic profiles of intentional user taps. For example, the wearable device uses the signature match confirmed 320 decision node to check if the frequency response and decay characteristics of the buffered signal match the expected kinematic profile of a human finger tapping the specific material of the device housing.

At 322, the wearable device takes a NO 322 path if the machine learning model classifies the impact as a false positive. The wearable device concludes the event was unintentional and returns to the low-power sampling module 302, allowing the high-power application domain 214 to re-enter a sleep state. For example, if the user claps their hands together, the resulting shockwave may pass the lower-level magnitude threshold, but the complex classifier identifies it as non-tap noise, prompting the wearable device to traverse the NO 322 path and power down.

At 324, the wearable device follows a YES 324 path to authorize an interaction if the wearable device identifies the signature as an intentional multi-level tap event. The wearable device prepares to execute the corresponding system operation based on the verified input. For example, when the machine learning model identifies the soft-tissue impact and precise frequency response of a double-tap gesture, the wearable device follows the YES 324 path to prepare a system-level response.

At 326, the wearable device executes an action execution module 326 to perform a programmatic response based on the confirmed tap signature. The wearable device accesses interaction configurations within the high-power application domain 214 to map the specific type of confirmed tap (such as a single tap, a double tap, or a tap at a specific spatial location on the housing) to a corresponding software command. For example, the wearable device uses the action execution module 326 to launch a digital assistant application, output a dynamic selection menu of user-defined actions, or start a workout tracking utility, thereby completing the multi-stage input detection cycle and translating the physical kinetic impact into a digital user interface response.

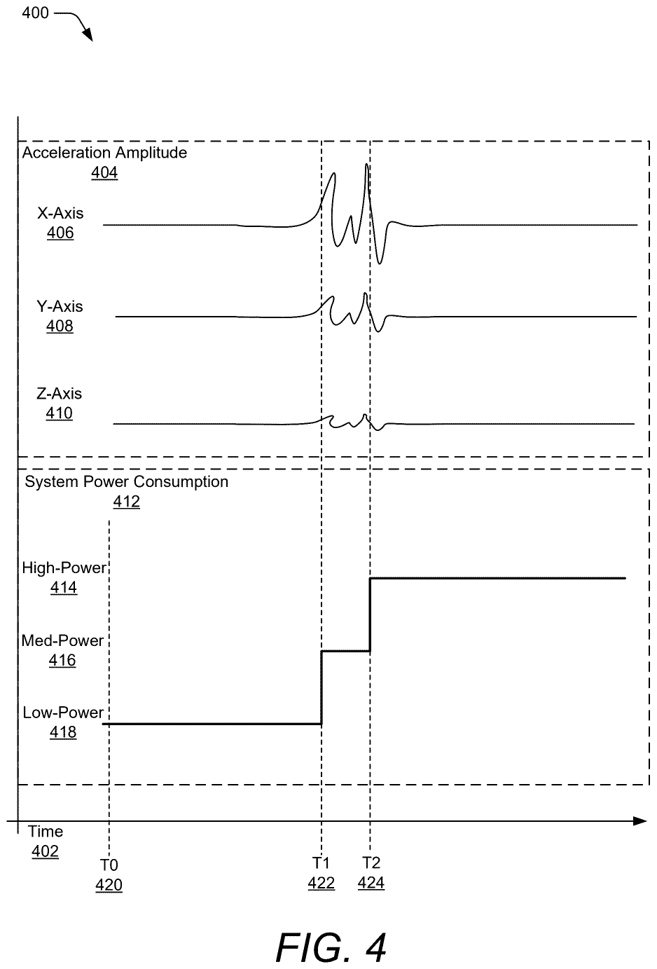

FIG. 4 illustrates an example overall waveform diagram 400 for power-managed physical impact detection for wearable devices. The overall waveform diagram 400 correlates a physical motion sensor data stream with internal device energy states to demonstrate how a computing apparatus manages processing resources in response to physical inputs. The operational events depicted in the overall waveform diagram 400 progress along a horizontal axis representing a time 402. By advancing along the time 402, the overall waveform diagram 400 maps a sequential transition of a device from an idle monitoring state through consecutive gating checks, which illustrates a progressive escalation in computational intensity and electrical draw based on captured physical activity.

An upper portion of the overall waveform diagram 400 depicts an acceleration amplitude 404. The acceleration amplitude 404 represents a magnitude of kinetic forces experienced by a motion sensor, such as an internal accelerometer, over the time 402. To capture complex multidirectional impacts, the acceleration amplitude 404 is separated into three distinct directional components: an x-axis 406, a y-axis 408, and a z-axis 410. The x-axis 406 may represent lateral or side-to-side acceleration forces across a plane of a device housing. The y-axis 408 may capture vertical or top-to-bottom forces, while the z-axis 410 tracks orthogonal forces, such as the pull of gravity or a physical impact striking a device directly. Together, the x-axis 406, the y-axis 408, and the z-axis 410 formulate a kinematic signature that the device evaluates to characterize a physical input.

A lower portion of the overall waveform diagram 400 depicts a system power consumption 412. The system power consumption 412 tracks a relative electrical current drawn by processing components of the device as different hardware domains wake up or transition between operational modes. The system power consumption 412 illustrates three discrete operational tiers. A high-power 414 state represents a condition where main processing units, machine learning accelerators, or user interface display drivers draw electrical current to perform classifications or execute system actions. A med-power 416 state represents an intermediate electrical draw, which may occur when a dedicated sensor hub or microcontroller temporarily increases a sampling rate or executes threshold logic without waking the main processors. A low-power 418 state corresponds to an idle or baseline background sensing mode where the device expends a relatively small amount of energy to maintain a low-frequency sensor data stream while major computational components remain asleep. The low-power 418 state may correspond to a first power state, and the med-power 416 state or high-power 414 state may correspond to a second power state that consumes more power than the first power state.

The overall waveform diagram 400 maps specific operational phases using sequential time intervals, beginning with a T0 420. At the T0 420, the device operates in a resting baseline phase. During this period, the acceleration amplitude 404 for the x-axis 406, the y-axis 408, and the z-axis 410 exhibits little fluctuation, which indicates that the device is relatively stationary and resting in a stable orientation. For example, a user may be holding their arm steady while reading text on a display or resting their hand on a table. Concurrently, at the T0 420, the system power consumption 412 operates at the low-power 418 state. In this state, the device conserves battery power by sampling the motion sensors at a low frequency to monitor for the continuation of the stable baseline condition.

As the device advances along the time 402, a kinetic event occurs at a T1 422. At the T1 422, a sudden spike in the acceleration amplitude 404 disrupts the stable baseline across the x-axis 406, the y-axis 408, and the z-axis 410. This spike indicates a physical impact against the device, such as a user tapping a side of the device housing with a finger. In response to detecting this initial steep slope or edge of the kinematic impact, the device shifts the system power consumption 412 from the low-power 418 state to the med-power 416 state. For example, at the T1 422, a low-power microcontroller may increase the sampling rate of the motion sensor from a first frequency to a second frequency to capture a higher-fidelity representation of the incoming mechanical wave. This increased sampling frequency inherently draws more electrical current but provides the data resolution to evaluate the vector and magnitude of the impact.

Following the initial impact detection and data capture, the device reaches a T2 424. At the T2 424, the device completes preliminary hardware-level gating checks and determines that the buffered waveform merits more rigorous analysis. Consequently, the device triggers a transition in the system power consumption 412 from the med-power 416 state to the high-power 414 state. At the T2 424, the device wakes a main application processor and transfers the high-fidelity sensor data to evaluate complex ringing and decay patterns of the multi-axis waveforms. For example, while the initial physical strike occurs at the T1 422, it is at the T2 424 that the device engages a machine learning model running on a main processor to confirm whether the specific oscillation pattern matches an intentional tap, which causes the system power consumption 412 to reach its peak operational draw.

In an example operational sequence illustrated by the overall waveform diagram 400, a user intends to trigger a quick-action shortcut on the device. Between the T0 420 and the T1 422, the user holds their arm still, which allows the device to maintain the low-power 418 state while confirming a stable baseline condition. At the T1 422, the user strikes the housing, which causes the device to detect the leading edge of the impact, step up to the med-power 416 state, and capture the mechanical resonance across the x-axis 406, the y-axis 408, and the z-axis 410. Once the preliminary threshold is met at the T2 424, the device escalates to the high-power 414 state, waking a central processor to execute a machine learning signature match to confirm the tap. Following the successful classification of the acceleration amplitude 404 data, the device executes the shortcut action while operating in the high-power 414 state, thereby utilizing a stepwise energy escalation to preserve battery resources during periods of inactivity or accidental bumping.

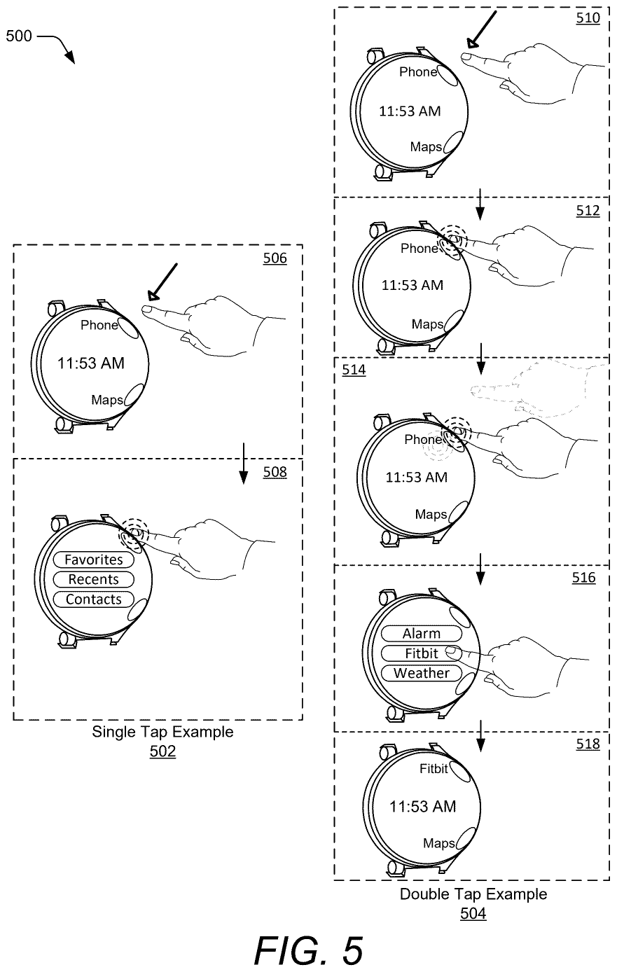

FIG. 5 illustrates an example overall UI example diagram 500 for power-managed physical impact detection for wearable devices. The overall UI example diagram 500 depicts how a computing apparatus, such as a wearable device, translates physical kinetic impacts against an exterior casing into corresponding digital user interface state changes. By mapping different kinematic impact patterns to specific software commands, the wearable device provides users with touch-free shortcuts to access applications, navigate menus, or reconfigure interface layouts.

The overall UI example diagram 500 illustrates two distinct interaction paths, demonstrating how the wearable device handles a single physical strike versus a rapid succession of physical strikes. Specifically, the overall UI example diagram 500 includes a single tap example 502 and a double tap example 504. The single tap example 502 illustrates a direct execution of a mapped feature or application launch based on a single localized impact. The double tap example 504 demonstrates a configuration interaction that allows a user to dynamically reassign system shortcuts or open a secondary menu by evaluating a multi-impact kinematic signature (e.g., taps that are approximately 350-500 milliseconds apart).

At 506, the wearable device operates in a baseline state and outputs a default interface that includes various graphical elements, such as a time indicator and text-based application shortcuts. For example, a user viewing a watch face that displays a “Phone” shortcut and a “Maps” shortcut decides to access communication features and brings a finger down toward an upper-right quadrant of a housing of the wearable device.

At 508, the wearable device captures a mechanical waveform generated by a physical strike, confirms a signature as an intentional single tap, and updates a display panel to present a new user interface menu. For example, in response to the user tapping the housing near the “Phone” indicator, the wearable device launches a communication application and outputs a menu listing “Favorites,” “Recents,” and “Contacts,” which allows the user to initiate a phone call without utilizing touch-based swiping to open an application drawer.

At 510, the wearable device presents an interaction sequence step 510 to begin the double tap example 504. The wearable device displays a primary user interface while continuing to monitor an internal motion sensor for new physical inputs. For example, after completing a workout, the user wants to reassign an on-screen shortcut from a phone dialer to a health tracking application and moves a finger toward an edge of the housing of the wearable device to initiate a configuration change.

At 512, the wearable device processes incoming kinetic data, identifies a leading edge of an initial physical impact against the exterior housing, and temporarily buffers a signal while initiating a brief timeout window to listen for a subsequent strike. For example, the user strikes the housing once, and the wearable device displays a brief visual ripple effect on the display panel near an impact location while waiting to determine if the input is a standalone tap or a first half of a multi-tap gesture.

At 514, the wearable device detects a second physical impact occurring within the brief timeout window, analyzes combined buffered data from the consecutive impacts, processes the combined buffered data through a machine learning classifier, and confirms an overall pattern as an intentional double tap event. For example, the user strikes the housing a second time approximately a few hundred milliseconds after the initial physical impact, and the wearable device verifies a distinct double-tap kinematic signature, filtering out unrelated physiological vibrations.

At 516, the wearable device replaces a default interface with a dynamic selection menu and provides a graphical user interface menu configured to reassign the action mapped to the intentional tap input (e.g., by allowing the user to select from a list of available applications or system actions). For example, the wearable device displays a scrollable selection menu containing options for an “Alarm,” a “Fitbit,” and a “Weather” application, and the user touches the “Fitbit” option on the display panel to select the “Fitbit” application as a new assigned quick-action shortcut.

At 518, the wearable device finalizes an interaction sequence step 518. The wearable device modifies an internal configuration profile to map a selected application to a corresponding shortcut position and renders an updated layout on the display panel to reflect a user selection. For example, following the user selection, the wearable device returns to the main watch face, but the previous “Phone” text is now replaced with “Fitbit” text, demonstrating how the double tap example 504 supports customization of a digital workspace using physical inertial inputs.

### Example Methods

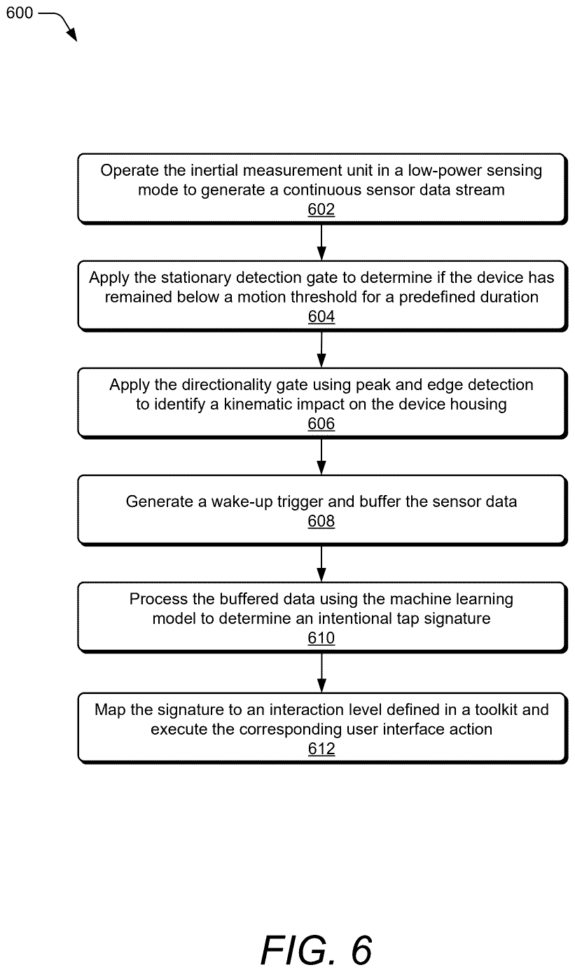

FIG. 6 illustrates an example method 600 for power-managed physical impact detection for wearable devices. Operations of the method 600 are implemented by or with wearable device 102.

Example method 600 is described with reference to FIG. 6 in accordance with one or more aspects of power-managed physical impact detection for wearable devices. Generally, the method 600 illustrates sets of operations (or acts) performed in, but not necessarily limited to, the order or combinations in which the operations are shown herein. Further, any of one or more of the operations may be repeated, combined, reorganized, omitted, or linked to provide a variety of additional and/or alternate methods. In portions of the following discussion, reference may be made to the entities of FIG. 1-5, reference to which is made for example only. The systems and methods described in this disclosure are not limited to embodiment or performance by one entity or multiple entities operating in relation to power-managed physical impact detection for wearable devices.

FIG. 6 illustrates an example overall method flowchart 600 for power-managed physical impact detection for wearable devices. The overall method flowchart 600 represents a sequence of operations that a computing apparatus, such as a wearable device, performs to detect, classify, and respond to physical impacts applied to an exterior housing. By executing these operations in a staged progression, the wearable device evaluates inputs through progressively more complex and power-intensive conditions, which facilitates accurate recognition of intentional user interactions while managing battery consumption.

At 602, the wearable device operates the inertial measurement unit in a low-power sensing mode to generate a continuous sensor data stream. To conserve electrical power, the wearable device delegates motion monitoring to a secondary, energy-efficient microcontroller rather than waking a main application processor. For example, while a user casually walks with an arm swinging naturally, the wearable device samples internal accelerometers at a reduced frequency, establishing the continuous sensor data stream without drawing substantial battery power.

At 604, the wearable device applies the stationary detection gate to determine if the device has remained below a predetermined motion threshold for a predefined duration. This filtering mechanism isolates deliberate user interactions from ambient physiological noise by establishing a relatively calm baseline. The wearable device analyzes the continuous sensor data stream to confirm that fluctuations in gravitational vectors do not exceed specific amplitude limits over a span of several hundred milliseconds. For example, when the user pauses and holds a wrist steady to view a display panel, the wearable device confirms that the localized movement dips below the motion threshold for the predefined duration, thereby clearing the condition to apply the stationary detection gate.

At 606, the wearable device applies the directionality gate using peak and edge detection to identify a kinematic impact on the device housing. Having established a stable baseline, the wearable device actively monitors the incoming data for sudden, steep changes in acceleration that indicate a physical strike against the exterior of the apparatus. By calculating vector angles and amplitude spikes, the wearable device filters out smooth movements. For example, if the user taps the side of the device housing with a finger, the wearable device uses peak and edge detection to identify the sharp mechanical shockwave entering the structure.

At 608, the wearable device generates a wake-up trigger and buffers the sensor data. In response to detecting the kinematic impact, the wearable device transitions from a hardware-level screening phase to a software-level analysis phase, which involves shifting processing workloads to more capable computing components. The wearable device captures a recent time window of the continuous sensor data stream, writing the values to a temporary memory structure, while simultaneously signaling a main processor to exit a sleep state. For example, the wearable device temporarily holds localized multi-axis acceleration data representing the physical tap in a first-in-first-out queue and sends a hardware interrupt to the main processor.

At 610, the wearable device processes the buffered data using the machine learning model to determine an intentional tap signature. The wearable device utilizes the awakened main processor to evaluate the frequency response, ringing characteristics, and decay patterns of the buffered sensor data. This evaluation compares the captured kinematic wave against trained profiles to distinguish a human finger tap from other sharp vibrations. For example, the wearable device analyzes the buffered data through a trained neural network, confirming that the impact possesses the soft-tissue dampening and specific resonance profile of an intentional finger tap, rather than misclassifying an accidental bump against a doorframe.

At 612, the wearable device maps the signature to an interaction level defined in a toolkit and executes the corresponding user interface action. The wearable device correlates the confirmed tap pattern (such as a single tap, a rapid double tap, or a location-specific tap) to a predefined software configuration. Following this resolution, the wearable device issues commands to a display controller or an operating system to reflect the input. For example, if the intentional tap signature indicates a double tap, the wearable device maps this gesture to a custom quick-action shortcut defined in the toolkit, launching a requested fitness tracking application or presenting a digital assistant menu on a display screen.

### Conclusion

Although aspects of power-managed physical impact detection for wearable devices have been described in language specific to features and/or methods, the subject of the appended claims is, as recited by any of the previous examples, not necessarily limited to the specific features or methods described. Rather, the specific features and methods are disclosed as example implementations of power-managed physical impact detection for wearable devices, and other equivalent features and methods are intended to be within the scope of the appended claims. Further, various aspects of power-managed physical impact detection for wearable devices are described, and it is to be appreciated that each described aspect may be implemented independently or in connection with one or more other described aspects.

What is claimed is:

1. A method comprising:
receiving, by at least one processor of a wearable device operating in a first power state, a sensor data stream from a motion sensor;
determining, by the at least one processor operating in the first power state, that a first portion of the sensor data stream satisfies a stability condition;
responsive to determining that the first portion satisfies the stability condition, detecting, by the at least one processor operating in the first power state, a physical impact on the wearable device based on a second portion of the sensor data stream;
responsive to detecting the physical impact, transitioning the at least one processor to a second power state that consumes more power than the first power state;
classifying, by the at least one processor operating in the second power state, the physical impact as an intentional tap input; and
executing an action mapped to the intentional tap input.

2. The method of claim 1, further comprising:
responsive to determining that the first portion satisfies the stability condition, increasing a sampling rate of the motion sensor from a first frequency to a second frequency, wherein the second portion of the sensor data stream is sampled at the second frequency.

3. The method of claim 1, wherein detecting the physical impact comprises analyzing the second portion of the sensor data stream using an edge detection algorithm to determine a physical location of the physical impact relative to a housing of the wearable device.

4. The method of claim 1, wherein classifying the physical impact as the intentional tap input comprises processing the second portion of the sensor data stream using a machine-learned model.

5. The method of claim 1, wherein the at least one processor comprises a microcontroller and a main processor, wherein the at least one processor operating in the first power state comprises the microcontroller being active while the main processor is in a sleep mode, and wherein transitioning the at least one processor to the second power state comprises the microcontroller sending a wake-up interrupt to the main processor.

6. A wearable device comprising:
a motion sensor;
at least one processor communicatively coupled to the motion sensor; and
at least one memory storing instructions that, when executed by the at least one processor, cause the wearable device to perform operations comprising:
receiving, while the at least one processor is operating in a first power state, a sensor data stream from the motion sensor;
determining, while the at least one processor is operating in the first power state, that a first portion of the sensor data stream satisfies a stability condition;
responsive to determining that the first portion satisfies the stability condition, detecting, while the at least one processor is operating in the first power state, a physical impact on the wearable device based on a second portion of the sensor data stream;
responsive to detecting the physical impact, transitioning the at least one processor to a second power state that consumes more power than the first power state;
classifying, while the at least one processor is operating in the second power state, the physical impact as an intentional tap input; and
executing an action mapped to the intentional tap input.

7. The wearable device of claim 6, wherein the at least one processor comprises a microcontroller and a main processor, wherein the at least one processor operating in the first power state comprises the microcontroller being active while the main processor is in a sleep mode, and wherein transitioning the at least one processor to the second power state comprises the microcontroller sending a wake-up interrupt to the main processor.

8. The wearable device of claim 7, wherein the operations further comprise:
buffering the second portion of the sensor data stream in the at least one memory while the at least one processor is operating in the first power state; and
responsive to transitioning the at least one processor to the second power state, providing the buffered second portion of the sensor data stream to the main processor to classify the physical impact.

9. The wearable device of claim 6, wherein determining that the first portion of the sensor data stream satisfies the stability condition comprises determining that an acceleration fluctuation along a gravity vector is below a predetermined threshold for a predefined duration.

10. The wearable device of claim 6, wherein the intentional tap input corresponds to a multi-tap event, and wherein executing the action comprises outputting a graphical user interface menu on a display of the wearable device, the graphical user interface menu configured to reassign the action mapped to the intentional tap input.
